(19) United States
(12) Patent Application Publication
(10) Pub. No.: US 2005/0157867 A1
(43) Pub. Date: Jul. 21, 2005

(54) Emergency call transmitter

(76) Inventors: Gunter Megner, Uhldingen (DE); Wolfram Hodapp, Zimmern (DE); Arthur Kopf, Schramberg (DE)

Correspondence Address: BURNS DOANE SWECKER & MATHIS L L P, POST OFFICE BOX 1404, ALEXANDRIA, VA, 22313-1404, US

(21) Appl. No.: 10/504,985

(22) PCT Filed: Jan. 10, 2003
(86) PCT No.: PCT/EP03/00166

(30) Foreign Application Priority Data
Feb. 20, 2002 (DE) 102 07 049.0

(51) Int. Cl. H04M 1/00; H04M 9/00

(52) U.S. Cl. 379/433.1

(57) ABSTRACT

An emergency call transmitter includes a housing formed by a substantially hollow cylindrical center piece which defines first and second opposite sides. A flange part is arranged on the first side, and a base part is arranged on the second side. At least one antenna wire passage is formed which leads out of an interior of the center piece. Disposed in the housing are an electric circuit element and a power supply device. An antenna wire is disposed in the housing and is arranged to be pulled out of the housing through the antenna wire passage. The antenna wire is formed of a memory material which aligns itself to a linear state once pulled from the housing.

### BACKGROUND OF THE INVENTION

The invention relates to a personal emergency call transmitter.

Emergency call transmitters on which the invention is based are known in the state-of-the art in a great number of variations. Emergency call transmitters are known in the airline industry by the English acronym ELT (Emergency Locator Transmitter), which transmit signals in case of an emergency at frequencies of 121.5 MHz or 243 MHz. Similar emergency call transmitters exist for the ship industry. Emergency call transmitters are now obligatory in commercial navigation, which transmit emergency call signals at a frequency of 406 MHz.

Emergency call signals of the aforementioned kind are intended to be received by a satellite-aided locating system and to be used to determine the position of the emergency call transmitter. A locating system of this type was established in 1979 by the U.S., the former USSR, Canada and France by the name of COSPAS-SARSAT-System (COSPAS is the acronym of the Russian term for the English wording of “Space System for the Search of Vessels in Distress”—SARSAT is the acronym for the English term “Search and Rescue Satellite-Aided Tracking”) and the system was expanded in 1996/1997.

Emergency call transmitters of the above-described type are commercially available mainly as built-in devices for installation on board of a ship or an aircraft. However, emergency call transmitters to be carried by a person can now also be purchased. Nevertheless, emergency call transmitters of the latter type have the disadvantage that a person carrying such a transmitter has to carry along a suitable carrying bag or the like to receive the emergency call transmitter.

Various measures are now known in the art to minimize the illustrated problems. For example, there are special holding straps that are directly attached to the housing of the emergency call transmitter. It has also been disclosed to integrate the emergency call transmitter with the housing of a wristwatch. The latter embodiment consists of a transmitting unit for frequencies of 121.5 MHz or 243 MHz, which are fixedly installed in the watch housing together with the clockwork. There are furthermore two antennas which are designed as wound-up spirals. Both antennas consist of wires made of a metal with very high nickel content. The metal wires are disposed in plastic tubes especially provided therefor during the inactive condition of the transmitter. The respective metal wires of the antenna can be pulled from the plastic tubes at the necessary length for transmitting of an emergency call signal.

Even though the last-mentioned version has turned out to be basically useful, there is still the desired goal to be able to equip any wristwatch in the lower or median price range with an emergency call transmitter without significantly increasing thereby the manufacturing and production costs and thus the sale price of the wristwatch.

It is thus the object of the invention to provide an emergency call transmitter that has small dimensions, on the one hand, and is light in weight, on the other hand.

The emergency call transmitter itself should be able to be manufactured in a cost-effective manner. To this end, nearly each commercially available wristwatch should be equipped with an emergency call transmitter of this type without experiencing additional costs in the production of the wristwatch.

### SUMMARY OF INVENTION

This object is achieved according to the invention by an emergency call transmitter which comprises a housing including a substantially hollow cylindrical center piece which defines first and second opposite sides. A flange part is arranged on the first side, and a base part is arranged on the second side. At least one antenna wire passage is formed which leads out of an interior of the center piece. An electric circuit element and a power supply device are mounted in the housing. An antenna wire is disposed in the housing and is arranged to be pulled out of the housing through the antenna wire passage. The antenna wire is formed of a memory material which aligns itself to a linear state once pulled from the housing.

The invention is generally based on an emergency call transmitter known from prior art, which comprises an electronic circuit element arranged in a housing to create at least one emergency call signal. This electronic circuit element is equipped with at least one antenna arrangement for the transmission of the emergency call signal. A power supply device is provided to operated the emergency call transmitter whereby said power supply device is preferably arranged in the housing as well.

The main concept of the invention is to use mechanical components known from the watch-making technology for the construction of the aforementioned emergency call transmitter. This was specifically realized in that the housing of the emergency call transmitter is designed in form of a wristwatch housing or a pocket watch housing having an essentially hollow cylindrical housing center piece, i.e. a so-called “carrure” or housing support with a flange part arranged on the back of the housing center piece, and having a base piece arranged on the face of the housing center piece.

The base piece is advantageously a watch crystal of a generally known type that is sealed against the housing center piece by means of a sealing ring, for example. The use of a watch crystal as a base piece has the advantage that a display element viewable from the outside, i.e. an LED or the like, can be installed to display the operational condition of the emergency call transmitter. The watch crystal can furthermore be imprinted in any desired manner—or any desired marking, illustrations etc. can be created on a previously applied layer of paint or lacquer by means of a laser beam whereby said markings can serve to explain the display element. The watch crystal can be easily opened with tools known in the watch-making technology for the removal of power sources, such as batteries or accumulators, for example, as well as for the purpose of maintenance and service.

It is proposed according to the invention that the housing center piece is designed as one piece together with the flange part. The housing center piece and the flange part can thereby be produced in one manufacturing step by machining, molding or stamping, for example.

An especially advantageous version of the invention proposes that the flange part is designed in such a manner that the housing can be inserted in the center piece of a wristwatch instead of being placed onto its base. In this way, it is made possible that any wristwatch can be equipped with an emergency call transmitter of the aforementioned type without needing to constructively change the wristwatch in any manner.

Since the majority of commercially available wristwatches are provided with a threaded back cover, which can be screwed into the bottom side of the housing support of the wristwatch, an embodiment version of an emergency call transmitter is proposed wherein the flange part is designed essentially cylindrical having outer threads whereby said flange part can be screwed into the inner threads provided on the center piece of the wrist watch so that the threaded back cover can be screwed in as well. It is understood for those skilled in the art that any other desired flange systems can be employed, such as bayonet-type connections, interference fit, snap connections, or fastening by screws with a plurality of screws or the like to be used, depending on the wristwatch onto which the emergency call transmitter is to be attached.

It is furthermore proposed according to the invention that at least one antenna wire passage is provided on the housing through which the antenna wire disposed in the housing can be pulled out and whereby said antenna wire is a component of at least one antenna arrangement. This version distinguished itself by its simple handling compared to an antenna arrangement in which the antenna wire is to be attached to the housing by means of a plug-in connection or a screw-in connection. In addition, the antenna wire does not have to be carried separately by a person.

An especially advantageous embodiment of the invention proposes that at least one antenna wire passage comprises an antenna-wire receiving tube, which is attached essentially tangential to the circumference of the essentially hollow cylindrical center piece. Said antenna wire passage can be sealed by means of a watch crown. The housing can be sealed to be waterproof to a depth of 200 meters.

It is further proposed according to the invention that the antenna wire consists of a memory material that aligns itself linear after being pulled from the housing. An additional tensioning device is thus not necessary.

The invention proposes furthermore a first inner ring that is arranged essentially coaxial within the housing center piece. This inner ring can fulfill different functions. On the one hand, it can form an interior chamber together with the base part and the flange part, which can receive the electronic circuit element of the emergency call transmitter and possibly the batteries serving as power supply elements. On the other hand, one or a plurality of antenna wires of one or several antenna arrangements can be wound about the outer circumference.

The inner ring consisting preferably of nonconductive material, such as synthetic material, is provided for this purpose with a first encompassing groove on its out circumference, according to the invention, on which at least the one antenna wire can be wound about. It is furthermore proposed that the first inner ring has an encompassing recess on its outer circumference into which a second inner ring is inserted essentially with a precise fit whereby the second inner ring is provided with a second encompassing groove on its outer circumference onto which an additional antenna wire can be wound about.

An especially advantageous version of the two latter embodiments proposes that the first inner ring and/or the second inner ring is rotatably mounted on a rotational axis relative to the housing so that unwinding of the antenna wire or the antenna wires is made possible in an easy manner.

### BRIEF DESCRIPTION OF DRAWINGS

An embodiment example of the invention is illustrated in the drawings and is described in more detail in the following:

FIG. 1 shows a plan view, partially sectioned, of an emergency call transmitter according to the invention, and

FIG. 2 shows the emergency call transmitter of FIG. 1 in an axial section along line A-A′.

### DESCRIPTION OF A PREFERRED EMBODIMENT

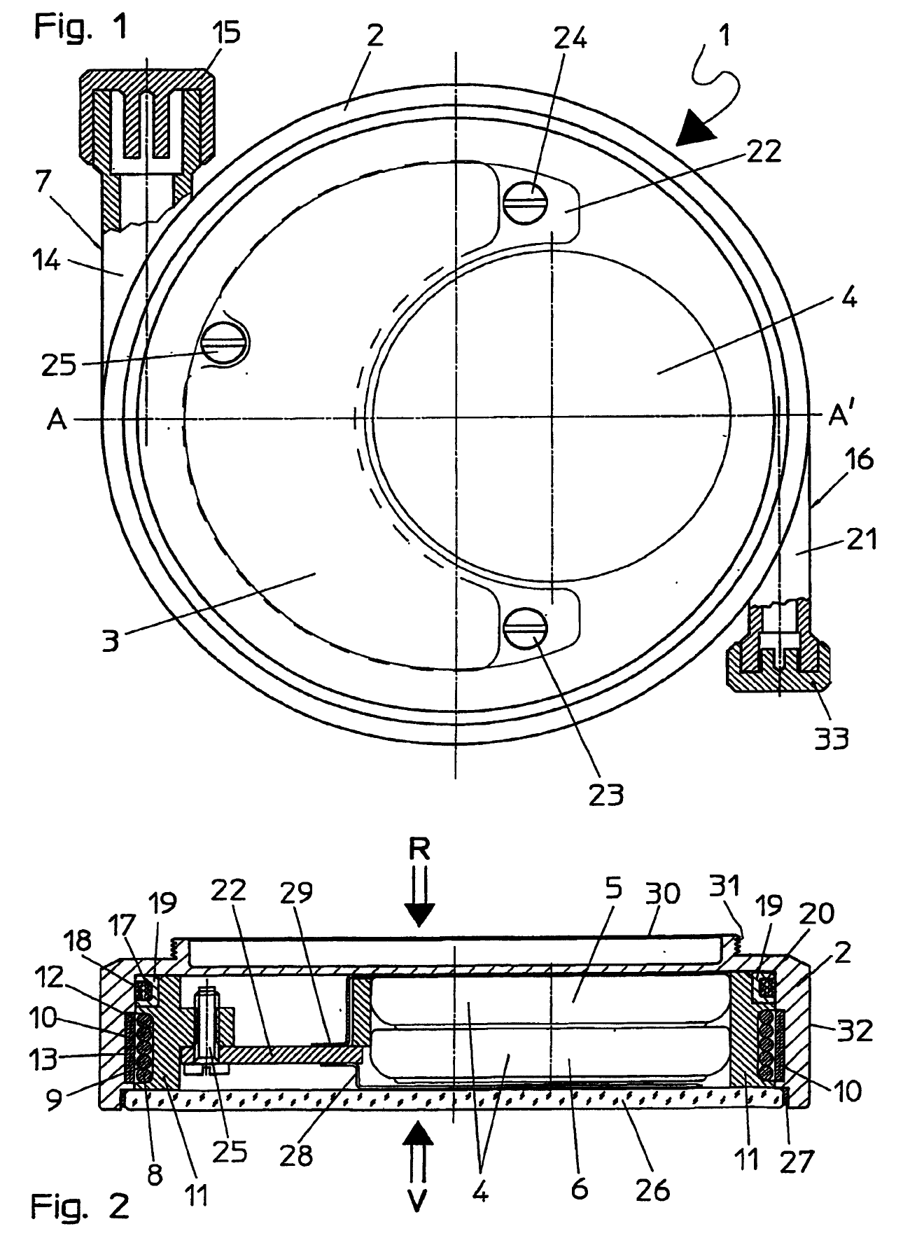

FIG. 1 and FIG. 2 show an embodiment example of an emergency call transmitter 1 according to the invention in a different sectional view.

One can see from the drawing the essential mechanical components of the emergency call transmitter 1, namely the housing 2, the electronic circuit element 3 arranged in the housing 2 to create the emergency call signal at a transmitting frequency of 121.5 MHz, 243 MHz and/or 406 MHz, for example, as well as the power supply device 4 also arranged in the housing 2 consisting of two batteries 5, 6, and two antenna arrangements 7, 16.

One can see the mechanical design of the inventive emergency call transmitter 1 in the drawn figures: The housing 2 of the emergency call transmitter 1 is designed in the way of a watch housing of the generally known type. It consists of an essentially hollow cylindrical center piece 32, a flange part 30 arranged on the back R of the housing center piece 32 and a watch crystal 26, also of a generally known type, forms the base part arranged on the face V of the housing center piece 32.

The watch crystal 26 is sealed against the housing center piece 32 by means of a sealing ring 27.

The housing center piece 32 forms a one-piece body together with the flange part 30. The flange part 30 is designed essentially cylindrical. It is provided with an outer thread 31. The dimensions of the cylindrical flange part 30 and especially the outer thread 31 are selected in a manner so that the housing 2 with the flange part 30 can be inserted into the center piece on the base of a wristwatch.

A first inner ring 11 made of nonconductive synthetic material is inserted into the housing 2 formed by the center piece 32, the watch crystal 26 and the flange part 30—more precisely, it is inserted essentially coaxial within the arrangement of the housing center piece 32. The electronic circuit element 3 is fastened to the first inner ring 11 within said inner ring 11 by means of three screws 23, 24 and 25 and the aforementioned batteries are enclosed by said circuit element in a semicircular fashion and serve as the electric power supply device, namely the first battery 5 and the second battery 6, which are designed as double button cells. The batteries 5, 6 are secured to the circuit element support 22 by means of two battery springs 28 and 29.

The first inner ring 11 is provided with a first encompassing groove 12 at its outer circumference onto which a first antenna wire 8 is wound about as a component of the first antenna arrangement 7.

The housing center piece 32 is provided with an encompassing groove 13 at its inner side corresponding to the axial dimensions of the encompassing groove 12 to electrically insulate the first antenna wire 8 against the housing center piece 32 whereby said groove is designated as the third encompassing groove 13. A first outer insulating ring 10 is inserted into said third encompassing groove 13. The space formed by the first encompassing groove 12 and the inner side of the first outer insulating ring 10 is designated as the first antenna chamber 9.

The first inner ring 11 is furthermore provided with an encompassing recess at its outer circumference into which a second inner ring 19 is inserted in an essentially fitting manner. The second inner ring 19 is provided, in turn, with a second encompassing groove 20 at its outer circumference onto which an additional second antenna wire 17 is wound about. The second encompassing groove 20 and the inner side of the housing center piece 32 define a second antenna chamber 18 similar to the aforementioned case.

Two antenna wire receiving tubes—the first and the second antenna wire receiving tubes 14 and 21—are provided on the housing 2 through which the antenna wires 8, 17 disposed in the housing 2 can be pulled out. The antenna wire receiving tubes 14, 21 are attached tangential on the outer circumference of the essentially hollow cylindrical center piece 32. The antenna wire receiving tubes 14, 21 can be respectively sealed on one side by means of the first and second watch crowns 15 and 33.

It is proposed according to the invention that the first inner ring 11 and the second inner ring 19 are rotatably mounted about a rotational center axis ax relative to the housing 2 so that the two antenna wires 8, 17 can be unwound from the inner rings 11, 19 serving as supports by applying a pulling force.

1-16. (canceled)

17. An emergency call transmitter comprising:
a housing including a substantially hollow cylindrical center piece defining first and second opposite sides, a flange part arranged on the first side, a base part arranged on the second side, and at least one antenna wire passage leading out of an interior of the center piece;
an electric circuit element mounted in the housing;
a power supply device mounted in the housing; and
an antenna wire disposed in the housing and arranged to be pulled out of the housing through the antenna wire passage, the antenna wire formed of a memory material which aligns itself to a substantially linear state once pulled from the housing.

18. An emergency call transmitter according to claim 16, wherein the base part comprises a watch crystal.

19. An emergency call transmitter according to claim 16 further including a sealing ring for sealing the base part relative to the housing center piece.

20. An emergency call transmitter according to claim 16 wherein the housing center piece is formed of one piece together with the flange part.

21. An emergency call transmitter according to claim 16 wherein the flange part is shaped to be mountable on a wrist watch base.

22. An emergency call transmitter according to claim 16 wherein the flange part is substantially cylindrical and provided with an outer thread adapted to be screwed into an inner thread provided on a wristwatch base.

23. An emergency call transmitter according to claim 16 wherein the at least one antenna wire passage comprises a receiving tube attached essentially tangentially to an outer circumference of the cylindrical center piece.

24. An emergency call transmitter according to claim 16, further including a removable watch crown sealing an outer end of the at least one antenna wire passage.

25. An emergency call transmitter according to claim 16, further including an inner ring arranged substantially coaxially within the housing center piece.

26. An emergency call transmitter according to claim 24, wherein the t inner ring comprises electrically nonconductive material.

27. An emergency call transmitter according to claim 25, wherein the inner ring comprises a synthetic material.

28. An emergency cell transmitter according to claim 24 wherein the antenna wire is wound within a space formed between an inner circumference of the center piece and an outer circumference of the inner ring.

29. An emergency call transmitter according to claim 24, wherein the inner ring is provided with a first encompassing groove on its outer circumference around which the antenna wire is wound.

30. An emergency call transmitter according to claim 29, wherein the inner ring constitutes a first inner ring and is provided with an encompassing recess on its outer circumference into which a second inner ring is fitted, wherein the second inner ring is provided with a second encompassing groove on its outer circumference around which an additional antenna wire is wound.

31. An emergency call transmitter according to claim 29, wherein at least one of the first inner ring and the second inner ring is rotatably mounted for rotation about a rotational axis relative to the housing.
